(19) United States
(12) Patent Application Publication
(10) Pub. No.: US 2003/0013200 A1
(43) Pub. Date: Jan. 16, 2003

(54) Liquid sample take-up device

(76) Inventors: Su-Cheng Pai, San Marino, CA (US); Alan Ying, San Marino, CA (US)

Correspondence Address: Kam C. Louie, Esq., c/o LADAS & PARRY, Suite 2100, 5670 Wilshire Boulevard, Los Angeles, CA, 90036-5679, US

(21) Appl. No.: 09/903,939

(22) Filed: Jul. 12, 2001

(51) Int. Cl. B01L 3/02

(52) U.S. Cl. 436/54; 422/100; 422/82; 422/81; 73/864; 73/864.21; 73/864.22; 436/52; 436/53

(57) ABSTRACT

The liquid sample take-up device comprises two layers of concentric tubing. An outer tube has a fluid take-up end for selective immersion in a liquid to be sampled, and a liquid connection spaced from the fluid take-up end adapted to receive a chemical reagent under pressure, creating a reagent flow toward the take-up end. An inner tube is disposed within the outer tube and has an open end adjacent to the outer tube take-up end. The inner tube is adapted to fluid connect to a negative pressure source, higher than the reagent pressure, to create a fluid flow within the inner tube in a direction away from the open end, whereby sampled liquid and reagent are mixed adjacent the inner tube open end and within the outer tube take-up end. When the outer tube take-up end is not immersed in a liquid to be sampled, air is drawn into the outer tube take-up end and into the inner tube open end, creating a series of air bubbles, each bubble separated by a volume of reagent.

### BACKGROUND OF THE INVENTION

1. Field of the Invention

This invention is related to the field of liquid sampling and testing, and more particularly to a device for taking up a liquid sample for subsequent detection, measurement, and/or analysis.

2. Brief Description of the Prior Art

A number of automated flow analyzers are commercially available, including: an Air-Segmented Flow AutoAnalyzer (Air-Segmented FAA, by Technicon); a non-air segmented Flow Injection Analyzer (FIA, introduced by Ruzicka and Hansen, reference being made to their book “Flow Injection Analysis”); and a Sequential Injection Analyzer (SIA, introduced by Ruzicka and colleagues). There is useful information about FIA on the internet at address http://www.flowinjection.com. This site gives a complete description of four generations of flow injection analysis by FIAlab Instruments, Inc. It is noted that all instruments mentioned by FIAlab Instruments, Inc. need a “carrier”.

The Air-Segmented FAA method employs a “bubble-segmentation” principle in the main stream of a sampled liquid to “segment”, or isolate, the sampled liquid from a carrier liquid, thereby preventing dispersion and dilution of the sampled liquid segment with the carrier flow.

The FIA and SIA methods use very narrow tubing in the manifold (i.e., mixing and reaction process), so that the dispersion of the sampled liquid with the carrier flow is limited by the “short” analysis time. All of the existing technology require a carrier flow and an injector or an autosampler to insert a fixed volume sample segment into the carrier flow.

Such prior art liquid sample analysis systems are complex, require precious professional time to setup and to clean after use, require a carrier flow or injector function, require excessive analysis time due to the chemical reaction starting downstream of the contact of the probe with a liquid sample, has reduced sensitivity and precision due to the existence of a carrier which may dilute the liquid sample, and may experience refractive index interference between the sample and the carrier.

Accordingly, there is a need in the art for an improved liquid sample take-up device which overcomes the aforementioned shortcomings, complexities, and analysis inaccuracies.

### SUMMARY OF THE INVENTION

The present invention satisfies the need in the art for an improved liquid sample take-up device.

In a preferred embodiment of the invention, there is provided a liquid sample take-up device, comprising: an outer tube having a fluid take-up end for selective immersion in a liquid to be sampled, and a liquid connection spaced from the fluid take-up end adapted to receive a chemical reagent under pressure, creating a reagent flow toward the take-up end; and an inner tube disposed within the outer tube and having an open end adjacent to the outer tube take-up end, the inner tube adapted to fluid connect to a negative pressure source, higher than the reagent pressure, to create a fluid flow within the inner tube in a direction away from the open end; whereby sampled liquid and reagent are mixed/encountered near the probe tip 11, or more precisely, adjacent the inner tube 3 open end and within the outer tube 7 take-up end, and the mixing continues within the inner tube 3 when the liquid is traveling toward the manifold M. Chemical reaction begins whenever the mixing starts.

In another aspect of the invention, there is provided a liquid sample take-up device, wherein, when the outer tube take-up end is not immersed in a liquid to be sampled, air is drawn into the outer tube take-up end and into the inner tube open end, creating a series of air bubbles, each bubble separated by a volume of reagent.

In a preferred construction, the liquid sample take-up device comprises rigid or flexible inner and outer tubes having circular cross sections and sized relative to one another such that a tubular passageway is defined between the inner and outer tubes, and the reagent progresses between the inner and outer tubes toward the inner tube open end.

In a practical embodiment of the invention, the liquid sample take-up device is constructed and configured in the form of a probe. Due to the nature of the fluid flow through the inner tube, the device may be referred to herein as a bubble-stream probe for use with virtually all types of automated liquid analysis systems, including flow injection analyzers (FIA) and bubble flow analyzers (BFA).

Employing the concepts of the present invention to a repeated liquid sampling procedure, i.e., when the outer tube take-up end is alternately immersed in and withdrawn from a liquid, or different liquids, to be sampled, multiple segments of flow through the inner tube are created comprising: a segment of a series of air bubbles separated by a volumes of reagent; a segment of a mixture of a liquid sample and reagent; another segment of a series of air bubbles separated by a volumes of reagent; and another segment of a mixture of a liquid sample and reagent. If different liquid samples are to be analyzed, the chain of bubbles and reagent between segments of liquid/reagent mix is effective to perform a self-cleaning function for the device, permitting instant reuse of the device without having to dismantle any of the components of the device for independent cleaning between samples.

### BRIEF DESCRIPTION OF THE DRAWING

These and other aspects of the invention will be better understood, and additional features of the invention will be described hereinafter having reference to the accompanying drawings in which:

FIG. 1 is a schematic representation of the structure and flow paths in a bubble-stream probe embodiment of the invention, when the probe tip is open to air;

FIG. 2 is an enlarged view of the top and bottom ends of the bubble-stream probe shown in FIG. 1;

FIG. 3 is a schematic representation of the structure and flow paths in a bubble-stream probe embodiment of the invention applied to a flow injection analysis (FIA) procedure;

FIG. 4 is a schematic representation of the structure and flow paths in a bubble-stream probe embodiment of the invention applied to a Steady-State Flow Analysis (SSFA) procedure in accordance with the invention;

FIG. 5 is a schematic representation of the structure and flow pattern in a bubble-stream probe embodiment of the invention applied to a Steady-State Flow Analysis (SSFA) procedure, in a “standby” mode;

FIG. 6 is a schematic representation of the structure and flow pattern in a bubble-stream probe embodiment of the invention applied to a Steady-State Flow Analysis (SSFA)procedure, in a liquid sample “take-up” mode;

FIG. 7 is a schematic representation of the structure and flow pattern in a bubble-stream probe embodiment of the invention applied to a Steady-State Flow Analysis (SSFA)procedure, in a stabilized mode in which the system is filled with the liquid sample and reagent mix, and a reading of the detector is taken for measurement of the sample; and

FIG. 8 is a schematic representation of the structure and flow pattern in a bubble-stream probe embodiment of the invention applied to a Steady-State Flow Analysis (SSFA)procedure, in an intermediate position of the probe after measurement of a first liquid sample and before immersion of the probe in a next liquid sample, a series of small bubbles shown being formed between the two sample segments to prevent mixing/carryover from each other.

### DETAILED DESCRIPTION OF THE PREFERRED EMBODIMENTS

In the accompanying drawing and description to follow, the steady-state-flow-analysis liquid sample take-up device according to the invention will be treated as a bubble-stream probe for convenience of presentation. It will be understood, however, that an arrangement other than in the appearance of a probe may be implemented. For example, a fixed Steady-State Flow Analysis (SSFA) station may mount the liquid sample take-up device permanently in position with the liquid take-up tip reciprocally movable by a handle, or the tip may be fixed in position with a reciprocally movable table/container arrangement.

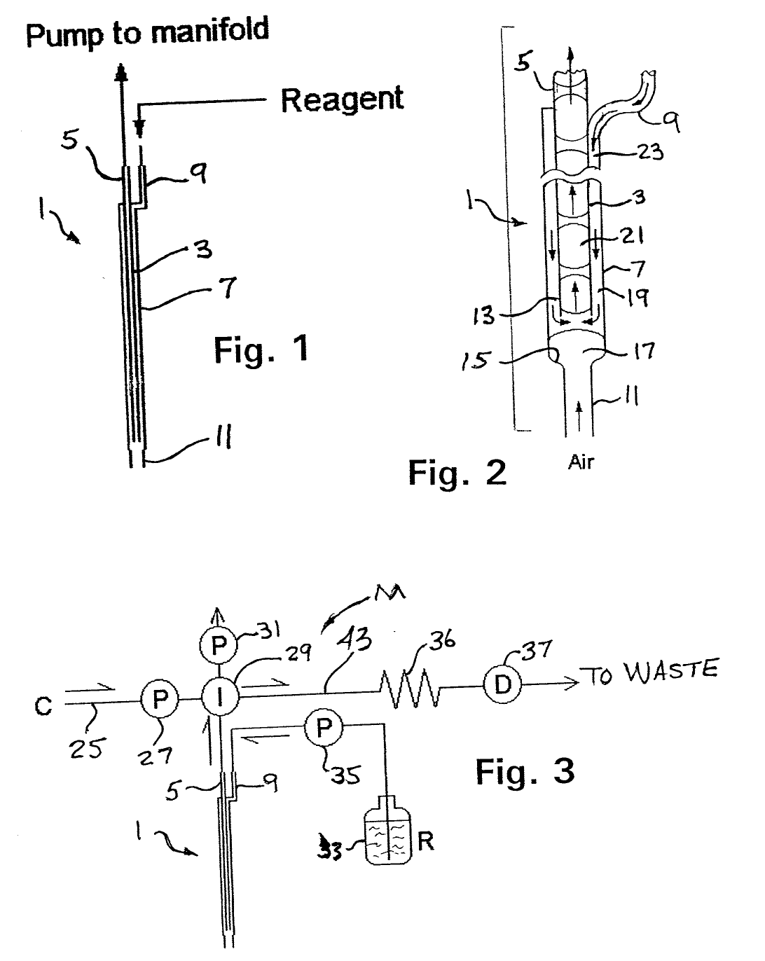

FIGS. 1 and 2 are schematic representations of the structure and flow pattern in an embodiment of a bubble-stream probe 1 in accordance with the invention, when the probe tip 11 is open to air, FIG. 2 being an enlarged divided view of the top and bottom ends of the bubble-stream probe shown in FIG. 1.

The probe device 1 shown in FIG. 1 is designed to uptake a liquid sample into a feed line, or manifold, for automated chemical analysis. The probe device 1 comprises two layers of tubing made of Teflon or glass/polypropylene materials, an inner tube 3 and an outer tube 7. While tubing having a circular cross section is preferred, the cross sectional shape may be of any geometric configuration suitable to function in the manner described herein.

The internal diameter of the outer tube 7 is larger than the outer diameter of the inner tube 3. For example, in a preferred embodiment, the outer tube 7 has a 3 mm outside diameter, and a 2 mm inside diameter; and the inner tube has a 1.9 mm outside diameter, and a 1 mm inside diameter, leaving a gap of 0.1 mm between the outer and inner tubes 7,3.

The length of the outer tube 7 is slightly longer than that of the inner tube 3, and the outer tube has a narrowed tip 11 as best seen in FIG. 2. Such construction defines a space, or chamber, near the tip 11 of the probe 1, and the narrowed bore at tip 11 holds liquid from dropping or flowing down when the probe is open to air or immersed in a liquid. The space, or chamber, below the bottom end 13 of inner tube 3 and above the shoulder 15 where the outer tube 7 begins to narrow toward tip 11, is being referred to herein as a chamber space 17. It is to be understood that, if the outer tube 7 is narrow enough to hold liquid within the tube 7, then the narrow tip 11 may not be needed.

An annulus 19 between the walls of the two tubes 3,7 is filled with chemical reagent 23 which is supplied through a reagent inlet 9 via another peristaltic pump (not shown) to provide a positive pressure and a steady flow rate of the chemical reagent 23 in a downward direction toward the bottom 13 of inner tube 3.

The bottom 13 of the inner tube 3 has an open end through which air or liquid sample enters, along with reagent, as will be described in detail below. The upper portion 5 of inner tube 3 is led to a peristaltic pump (not shown) that generates a controlled negative pressure to ensure the air or liquid entering the system through tip 11 is pumped at a steady flow rate in the upward direction, along with reagent 23 entering the chamber space 17 or the probe tip 11.

The reagent flow in the annulus 19 is controlled at a rate much less than the uptake rate of the inner tube 3, so that the liquid reagent 23 will not drip out of the tip 11 of the probe 1.

It will be understood that the phrase “open end” as used herein is not limited to a cut-off end of the inner tube 3. Openings may be provided in the sidewall of the inner tube 13 adjacent its distal end, in addition to, or instead of, a conventional end cut-off opening.

In operation, when the bubble-stream probe 1 is open to air, the liquid reagent 23 and air forms a stream of bubbles 21. After the probe 1 is inserted into a liquid sample, the air bubbles 21 are replaced by the sampled liquid entering tip 11. The liquid sample will be initially mixed with reagent 23 promptly and proportionally in the chamber space 17 immediately adjacent tip 11 of the probe 1. Mixing of the sampled liquid and reagent 23 continues within the annulus 19 by dispersion and diffusion while the liquid is taken up. The reagent and liquid sample mixture, drawn by a peristaltic pump, progresses toward a manifold or detecting device (not shown). When the measurement and/or analysis is complete, the probe 1 is lifted from the liquid sample source, and a bubble stream again forms immediately. The length along the inner tube 3 and manifold M (FIGS. 3-8) of reagent/liquid-sample drawn into inner tube 3 is herein referred to as a segment of the liquid sample.

Accordingly, the generation of a bubble stream between samples simulates a segmentation of drawn liquid samples in order to prevent the carry-over, or residue, of one sample segment with the next sample. In this sense, the creation of a bubble stream of air and reagent between liquid sample segments, in effect, is a self-cleaning function, cleaning the interior of the inner tube 3 of any residual in the probe 1 of the previous liquid sample.

It is to be noted that the sample uptake technology unique to the present invention saves analysis time. Since the reagent is introduced at the tip 11 of the probe 1, the chemical reaction starts instantaneously at contact with the sample liquid, thereby saving precious analysis time. Thus, unlike prior art automated flow analysis systems, in which the sample is taken up or withdrawn by a simple narrow tubing while a reagent is introduced and mixing occurs at a second, downstream, stage, the present invention mixes a wet sample with a reagent in a single stage and starts the chemical reaction at the tip 11 of the probe 1.

While the invention is fully operative and effective without need for a carrier, it can be adapted to any type of automated analysis system, including a flow injection analyzer (FIA, which uses a carrier) and a bubble flow analyzer (BFA).

FIG. 3 is a schematic representation of the structure and flow paths in a bubble-stream probe embodiment of the invention applied to a flow injection analysis (FIA) procedure. A carrier C is provided through carrier inlet 25, drawn into the system by a peristaltic pump 27 and applied to an injector I where the liquid sample and reagent mixture, drawn upwardly by peristaltic pump 31, is carried by the carrier toward a manifold M or detector 37. Reagent is supplied from a reagent source 33 through peristaltic pump 35 and into the reagent inlet 9.

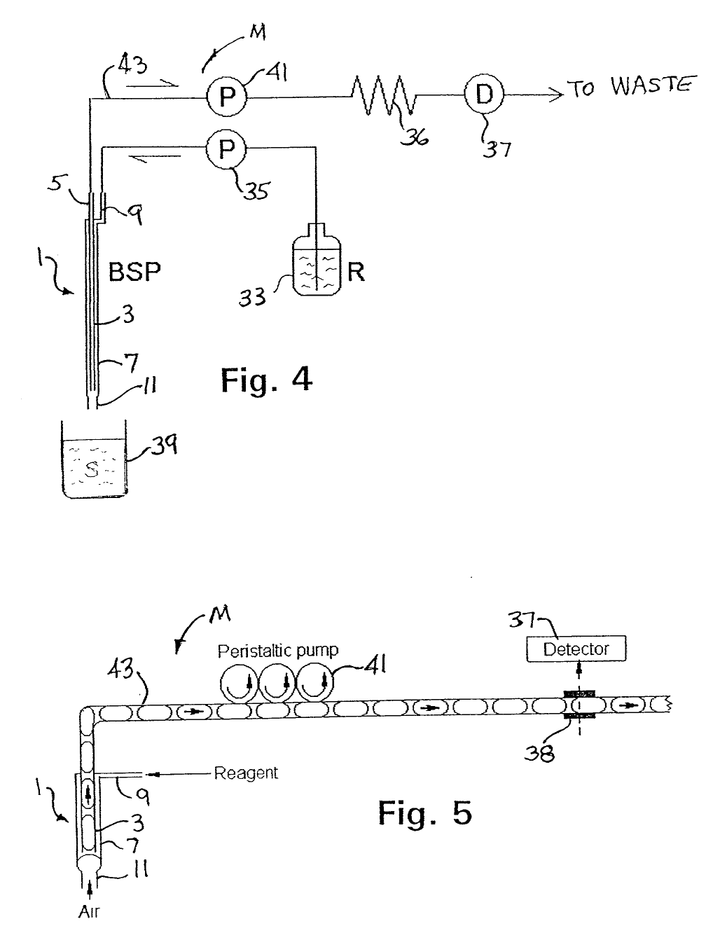

FIG. 4 is a schematic representation of the structure and flow paths in a bubble-stream probe embodiment of the invention applied to a Steady-State Flow Analysis (SSFA) procedure. Here, chemical reagent is applied to the reagent inlet 9 in the manner described in connection with FIG. 3. FIG. 4 depicts a container 39 of liquid to be sampled, and a peristaltic pump 41 provides the appropriate controlled negative pressure to draw the reagent and liquid sample up through the inner tube 3 and on to the detector 37.

In any of the systems described herein, an optional mixing coil 36 may be provided to homogenize the sample segment and provide time delay for a complete chemical reaction to take place.

Broadly, in a Steady-State Flow Analysis (SSFA), the methodology includes a chemical analysis based on sequentially introduced liquid samples into a continuous reagent flow, and the final chemical product is measured in a continuous manner by a detector 37. The loading of a liquid sample S in this manner is based on the “air/sample replacement” principle, and liquid sample segments are isolated by a stream of bubbles in a reagent flow provided between successive liquid sample segments.

FIGS. 5, 6, and 7 are schematic representations of the structure and flow pattern in a bubble-stream probe embodiment of the invention applied to a Steady-State Flow Analysis (SSFA) procedure.

In all of the embodiments of the invention depicted and described herein, the peristaltic pumps provide the appropriate flow rates for the main stream of air or liquid sample, and for the reagent.

The purpose of the detecting flow cell 38, associated with detector 37, is to detect the presence of continuous liquid passing through the system (without bubbles). If a bubbleless flow is detected, i.e., if the detecting flow cell 38 is completely filed with liquid, this is evidence that the flow is ready for analysis.

In FIG. 5, the probe tip 11 is not immersed in a liquid to be sampled, and therefore draws air and reagent into the system, creating a series of bubbles in the inner tube 3 and feed line 43 of manifold M. In this condition, the system is in a “standby” mode.

To initialize the system prior to analyzing liquid samples, the probe tip 11 is inserted into a container of distilled water (not shown) to provide a blank flow. When the entire manifold M and detecting flow cell 38 are completely filled, the detector 37 is zeroed. This typically involves the flow of distilled water through the manifold M, followed by a “standard” solution of know concentration(s). Although the samples may be colorless, when mixed with a specific reagent, the substance (analyte) contained in the sample will start a color reaction. When the mix arrives at the detector 37, a photo detector device within detector 37 will produce a photoelectric signal which is proportional to the concentration of the analyte. The detector 37 measures photoelectric signals, in volts, proportional to the concentration of the standard solution. Multiplying the measured photoelectric signal by a factor converts the measurement to a concentration. This establishes a concentration “zero” reference based on the standard solution measurement. Once the calibration is completed, the system is ready to measure samples, and all subsequent photoelectric signals detected can be converted to concentrations.

The probe 1 is then lifted from the distilled water to allow an air/reagent bubble stream to form. The system is now ready to take-up a first liquid sample.

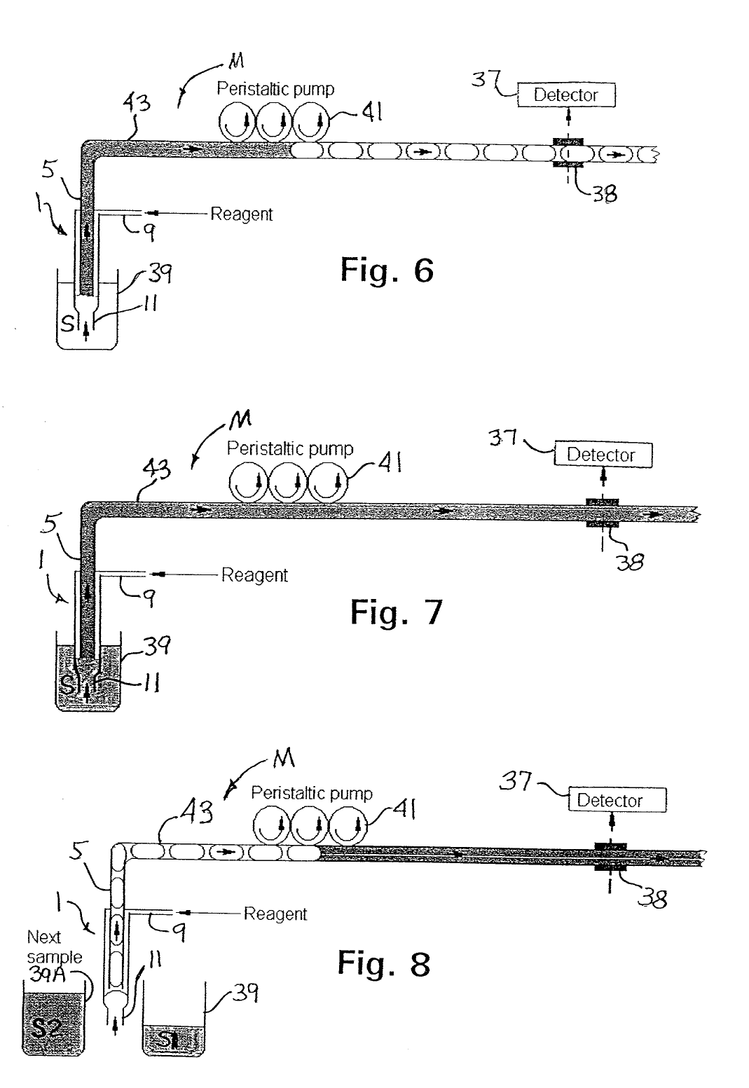

The probe 1 is then inserted into the liquid sample S in container 39, as seen in FIG. 6. Immediately, the liquid sample S begins to fill the feed line 43 of manifold M, as the air bubbles are replaced by the liquid sample. As liquid sample is drawn into the system, a chemical reaction starts at the tip 11 between the liquid sample and the reagent and continues as the mixture traverses its path through the manifold M. Filling of the manifold M continues until the liquid sample fills the entire system and the reading of the detector 37 is stable, as shown in FIG. 7. A measurement or analysis of the sampled liquid is then made and recorded. Then, the probe 1 is lifted from the liquid sample surface (FIG. 8), resulting in another air/reagent bubble stream flow, and the system is ready for the next sample.

FIG. 8 is a schematic representation of the structure and flow pattern in a bubble-stream probe embodiment of the invention applied to a Steady-State Flow Analysis (SSFA)procedure, in an intermediate position of the probe 1, after measurement of a first sample S1 in container 39 and before immersion of the probe 1 in the next liquid sample S2 in container 39A.

In light of the above description of the various embodiments, implementations, and adaptions of the invention, a number of advantages of the invention over prior art automated flow analysis systems become evident, representative ones of which are:

1. It does not need a carrier flow, but is adaptable to prior art automated flow analysis systems employing a carrier.

2. It does not require an injector, but is adaptable to prior art automated flow analysis systems employing an injector.

3. It has a Bubble-Stream Probe 1 to uptake samples. The “Steady-State Flow Analysis (SSFA)” is neither “Air-Segmented FAA” nor “FIA” in principle. However, it takes the advantages of the both. When the sample is off-line, the system performs like the Air-Segmented FAA; when the sample is online, it becomes an “FIA with no injector”. The continuous sequencing of “loading of sample” and “open to air” functions is analogous to a continuous on-and-off sequence.

To an analyst who uses the SSFA system, the major advantages are:

1. It saves analysis time because the chemical reaction starts at the contact of the probe with the sample;

2. The lack of the “injection” operation saves maneuvering—all the analyst needs to do is to put the sample in loading position and to wait for the result;

3. It has higher sensitivity because there is no carrier to dilute the sample;

4. It has no refractive index interference between the sample and carrier; and

5. At the same criteria, the precision of SSFA is higher than other automated methods.

Another major breakthrough of the SSFA technology is that the sample segment flows through peristaltic pumping without being affected by the difference of tube diameter in the main stream, while other techniques always inject samples at a position after the peristaltic pump. The key merit is provided by the “Bubble-Stream Probe” 1 (BSP), which separates two sample segments perfectly even in the soft pumping tube.

While only certain embodiments of the invention have been set forth above, alternative embodiments and various modifications will be apparent from the above description and the accompanying drawing to those skilled in the art. For example, software may be added on the output analyzing instrument or device to exclude any non-steady signal from display in the event the reading of the detector “jumps” when bubbles flow through the detecting flow cell 38. As another example, with further development of new system design parameters which reduce the volume size needed for reliable and accurate analysis, the invention may be suitable for liquid sample volumes under 10 ml. These and other alternatives are considered equivalents and within the spirit and scope of the present invention.

What is claimed is:

1. A liquid sample take-up device, comprising:
an outer tube having a fluid take-up end for selective immersion in a liquid to be sampled, and a liquid connection spaced from said fluid take-up end adapted to receive a chemical reagent under pressure, creating a reagent flow toward said take-up end; and
an inner tube disposed within said outer tube and having an open end adjacent to said outer tube take-up end, said inner tube adapted to fluid connect to a negative pressure source, higher than the reagent pressure, to create a fluid flow within said inner tube in a direction away from said open end; whereby
sampled liquid and reagent are mixed adjacent said inner tube open end and within said outer tube take-up end.

2. The liquid sample take-up device as claimed in claim 1, wherein:
when said outer tube take-up end is not immersed in a liquid to be sampled, air is drawn into said outer tube take-up end and into said inner tube open end, creating a series of air bubbles, each bubble separated by a volume of reagent.

3. The liquid sample take-up device as claimed in claim 1, wherein:
said outer tube liquid connection provides a steady flow rate of reagent toward said take-up end.

4. The liquid sample take-up device as claimed in claim 1, wherein:
said inner tube fluid connection provides a steady flow rate of air or liquid in a direction away from said inner open end and said outer take-up end.

5. The liquid sample take-up device as claimed in claim 1, wherein:
said inner tube is sized relative to said outer tube to define a tubular passageway between said inner and outer tubes; and
said reagent progresses between said inner and outer tubes toward said inner tube open end and said outer tube take-up end.

6. The liquid sample take-up device as claimed in claim 2, wherein, when said outer tube take-up end is alternately immersed in and withdrawn from a liquid, or different liquids, to be sampled, multiple segments of flow through said inner tube are created comprising:
a segment of a series of air bubbles separated by volumes of reagent;
a segment of a mixture of a liquid sample and reagent;
another segment of a series of air bubbles separated by volumes of reagent; and
another segment of a mixture of a liquid sample and reagent.

7. A liquid sample take-up device, comprising:
an outer tube having an interior, said outer tube having a first end and an open second end; and
an inner tube having an interior and disposed within said outer tube, said inner tube having a first end and an open second end and sized to define a tubular passageway between said inner and outer tubes; wherein said first end of said inner tube is adapted to fluid connect to a negative pressure source, creating a fluid flow within said inner tube at a predetermined flow rate;
said first end of said outer tube is adapted to fluid connect to a positive pressure chemical reagent source, creating a reagent flow rate less than the flow rate of fluid within said inner tube;
said open second end of said outer tube extends beyond said open second end of said inner tube, said open second end of said outer tube functioning as a fluid take-up end; and
said chemical reagent progresses toward said second end of said inner tube and is taken up by negative pressure in said inner tube.

8. The liquid sample take-up device as claimed in claim 7, wherein:
when said outer tube take-up end is not immersed in a liquid to be sampled, air is drawn into said outer tube take-up end and into said inner tube open end, creating a series of air bubbles, each bubble separated by a volume of reagent.

9. The liquid sample take-up device as claimed in claim 7, wherein:
said outer tube liquid connection provides a steady flow rate of reagent toward said take-up end.

10. The liquid sample take-up device as claimed in claim 7, wherein:
said inner tube fluid connection provides a steady flow rate of air or liquid in a direction away from said inner open end and said outer take-up end.

11. The liquid sample take-up device as claimed in claim 7, wherein:
said reagent progresses between said inner and outer tubes toward said inner tube open end.

12. The liquid sample take-up device as claimed in claim 8, wherein, when said outer tube take-up end is alternately immersed in and withdrawn from a liquid, or different liquids, to be sampled, multiple segments of flow through said inner tube are created comprising:
a segment of a series of air bubbles separated by volumes of reagent;
a segment of a mixture of a liquid sample and reagent;
another segment of a series of air bubbles separated by volumes of reagent; and
another segment of a mixture of a liquid sample and reagent.

13. A method of chemical analysis, comprising:
providing a liquid sample take-up device having a take-up end, an outlet, and a chamber space within the device and in close proximity to the take-up end;
selectively immersing the fluid take-up end of the device in a liquid or liquids to be sampled;
introducing a chemical reagent into the chamber space, while simultaneously drawing liquid sample through the take-up end;
mixing the sampled liquid and reagent in the chamber space; and
routing the mixed sampled liquid and reagent along a manifold to a liquid sample analyzer.

14. The method as claimed in claim 13, wherein:
when the fluid take-up end is not immersed in a liquid to be sampled, air is drawn into the take-up end, creating a series of air bubbles in said manifold, each bubble separated by a volume of reagent.

15. The method as claimed in claim 13, wherein:
a steady flow rate of reagent is introduced into the chamber space.

16. The method as claimed in claim 13, wherein:
a steady flow rate of air or liquid is drawn through the take-up end, the flow rate of air or liquid through the take-up end being greater than the flow rate of reagent introduced into the chamber space.

17. The method as claimed in claim 13, wherein:
when the take-up end is alternately immersed in and withdrawn from a liquid, or different liquids, to be sampled, multiple segments of flow through said liquid sample take-up device are created, comprising:
a segment of a series of air bubbles separated by volumes of reagent;
a segment of a mixture of a liquid sample and reagent;
another segment of a series of air bubbles separated by volumes of reagent; and
another segment of a mixture of a liquid sample and reagent.

18. The method as claimed in claim 14, comprising, prior to immersing the fluid take-up end of the device in a liquid or liquids to be sampled:
providing a flow detecting device along the route of the mixed sampled liquid and reagent for detecting when the manifold is absent of bubbles;
introducing distilled water in place of the liquid sample to provide a blank flow; and
zeroing the liquid sample analyzer when the entire manifold is completely filled with distilled water.
